(19) United States
(12) Patent Application Publication
(10) Pub. No.: US 2017/0301044 A1
(43) Pub. Date: Oct. 19, 2017

(54) SYSTEMS AND METHODS FOR MANAGING OUTAGES IN UTILITY SYSTEMS

(71) Applicant: ORACLE INTERNATIONAL CORPORATION, Redwood Shores, CA (US)

(72) Inventors: Jason J. DUNCAN-WILSON, Cincinnati, OH (US); Lawrence NELSON, Kingwood, TX (US); David SISKA, Oakland, CA (US)

(21) Appl. No.: 15/099,664

(22) Filed: Apr. 15, 2016

(51) Int. Cl. G06Q 50/06; H04Q 9/00

(52) U.S. Cl. CPC G06Q 50/06; H04Q 9/00; H04Q 2209/60

(57) ABSTRACT

Systems, methods, and other embodiments are disclosed for managing utility usage data in the event of a utility outage. In one embodiment, measured meter data is read representing utility usage data collected from multiple meters within a zone of a utility system and processed to identify valid and invalid usage data of the measured meter data. An estimation process is performed on the measured meter data to generate corrected meter data for the multiple meters. The corrected meter data is aggregated over a time span to generate an aggregate percentage value specifying a total percentage of data received for the time span. The aggregate percentage value is compared to a threshold value to detect a utility outage. The estimation process is suppressed for the multiple meters when the aggregate percentage value is below the threshold value, indicating a utility outage.

### BACKGROUND

A consumption meter measures usage (i.e., consumption) over time of, for example, electricity, natural gas, or water by a customer of a utility provider. Traditional interval consumption meters and newer advanced metering infrastructure (AMI) “smart” consumption meters are minimally configured with two channels of consumption data being that of, for example, interval consumption data and register (scalar) consumption data. Currently, a large volume of data is received from AMI smart meters on the electrical grid into either customer systems or meter data management applications at utilities. This data is received frequently, for example, often daily or intra-daily.

When a large storm (e.g., a hurricane, a tornado, an ice storm) hits a territory, the electrical grid is usually damaged significantly, resulting in electrical power outages. With new advanced metering infrastructure (AMI) meter technology, such storms also impact the reception of electrical usage information from the meters because an AMI meter relies on having electrical power to communicate the electrical usage information. Furthermore, the communication network used to communicate the electrical usage information is often impacted by such storms as well.

A utility often estimates the usage of customers based on usage information from the customer AMI meters. Such estimates are used for billing the customers. A utility outage may corrupt data from the meters and interfere with data collection.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a computer system, having a computing device configured with utility outage detection logic;

FIG. 2 illustrates one embodiment of a method, which can be performed by utility outage detection logic of the computer system of FIG. 1, for suppressing the estimation of usage data during a utility outage;

FIG. 3 graphically illustrates an example embodiment of a process of suppressing usage estimation upon detecting a utility outage, and resuming usage estimation once the utility outage is over.

FIG. 4 illustrates an example power outage scenario as handled by the system of FIG. 1 using the method of FIG. 2; and

FIG. 5 illustrates one embodiment of a computing device upon which utility outage detection logic of a computing system may be implemented.

### DETAILED DESCRIPTION

Systems, methods, and other embodiments are disclosed that detect when a utility outage (e.g., an electrical power outage) has occurred within a postal code zone and that suppress an estimation of usage data for meters within the postal code zone when the outage is detected. By suppressing the estimation of usage data during an outage, overbilling of customers can be prevented, as discussed later herein. Furthermore, estimation can be resumed for each meter, for example, once the system determines that electrical power has been restored. Even though systems, methods, and other embodiments can apply to any of electrical, water, or gas utilities, examples provided herein focus on that of an electrical utility.

In accordance with one embodiment, utility outage detection logic is disclosed that is configured to detect an outage on the electrical grid for a large number of meters. A percentage of data received each day from the electrical meters within a postal code zone is calculated and compared to a median percentage of data received from other days in a number of previous weeks, for example. If the percentage of data received drops significantly (e.g., based on a threshold percentage), then a widespread outage is assumed for that zone of meters. As a result, estimation of electrical usage is suppressed for the zone of meters until at least one meter in the zone indicates that the zone has recovered from the outage.

The following terms are used herein with respect to various embodiments.

The term “measured meter data”, as used herein, refers to utility usage data that is generated by one or more utility meters connected to a utility system. For example, electrical usage data represents properties related to an amount of electricity used by each customer that is monitored and measured by the electrical meters. The properties may include, for example, meter ID, customer ID, physical address location, amount of used electricity, date and time, etc. The electrical usage data is generated as interval consumption data, register (scalar) consumption data, or both. The term “measured meter data”, as used herein, can refer to recent usage data before or after being processed through a validation process.

The term “head-end device”, as used herein, refers to a device that is configured to collect utility usage data from a utility system (e.g., from an electrical grid).

The term “powered up”, as used herein, refers to electrical power being applied to a device (e.g., to an electrical meter).

The term “zone”, as used herein, refers to a region or area where multiple utility meters are deployed (e.g., within a region characterized by a same postal code).

The term “service point”, as used herein, refers to a physical location of a utility meter.

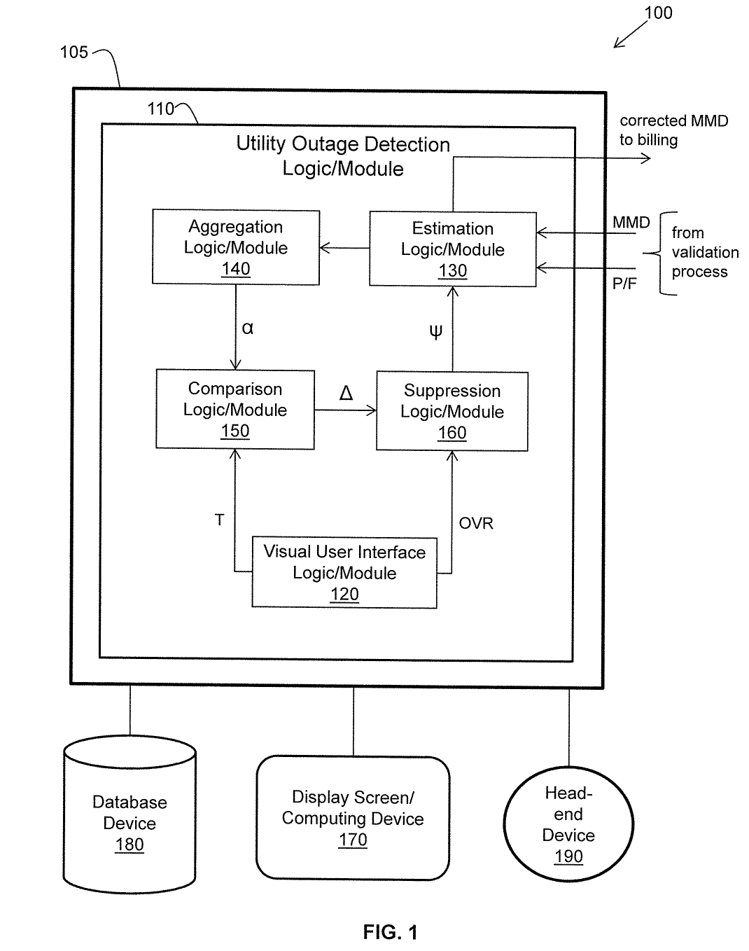

FIG. 1 illustrates one embodiment of a computer system 100, having a computing device 105 configured with utility outage detection logic 110. For example, in one embodiment, utility outage detection logic 110 may be part of a larger computer application (e.g., a computerized utility management application), configured to help manage various aspects of a utility company including billing of customers. Utility outage detection logic 110 is configured to computerize the process of suppressing the estimation of utility usage data based on measured meter data (MMD) collected from a utility system when a utility outage is detected. The embodiments described herein take into consideration measured meter data that includes interval consumption data, register (scalar) consumption data, or both.

Utility outage detection logic 110 is also configured to computerize the process of controlling when the estimation of utility usage data is to be performed to generate more accurate usage data to avoid over-billing customers. In one embodiment, the system 100 is a computing/data processing system including an application or collection of distributed applications for enterprise organizations. The applications and computing system 100 may be configured to operate with or be implemented as a cloud-based networking system, a Software as a Service (SaaS) architecture, or other type of computing solution.

With reference to FIG. 1, in one embodiment, utility outage detection logic 110 is implemented on the computing device 105 and includes logics or modules for implementing various functional aspects of utility outage detection logic 110. In one embodiment, utility outage detection logic 110 includes visual user interface logic/module 120, estimation logic/module 130, aggregation logic/module 140, comparison logic/module 150, and suppression logic/module 160.

Other embodiments may provide different logics or combinations of logics that provide the same or similar functionality as utility outage detection logic 110 of FIG. 1. In one embodiment, utility outage detection logic 110 is an executable application including algorithms and/or program modules configured to perform the functions of the logics. The application is stored in a non-transitory computer storage medium. That is, in one embodiment, the logics of utility outage detection logic 110 are implemented as modules of instructions stored on a computer-readable medium.

The computer system 100 also includes a display screen 170 operably connected to the computing device 105. In accordance with one embodiment, the display screen 170 is implemented to display views of and facilitate user interaction with a graphical user interface (GUI) generated by visual user interface logic 120 for viewing parameters and generating commands associated with the suppression of a utility usage estimation process. The graphical user interface may be associated with a utility outage detection algorithm and visual user interface logic 120 may be configured to generate the graphical user interface.

In one embodiment, the computer system 100 is a centralized server-side application that provides at least the functions disclosed herein and that is accessed by many users via computing devices/terminals communicating with the computer system 100 (functioning as the server) over a computer network. Thus the display screen 170 may represent multiple computing devices/terminals that allow users to access and receive services from utility outage detection logic 110 via networked computer communications.

In one embodiment, the computer system 100 further includes at least one database device 180 operably connected to the computing device 105 and/or a network interface to access the database device 180 via a network connection. For example, in one embodiment, the database device 180 is operably connected to estimation logic 130. In accordance with one embodiment, the database device 180 is configured to store and manage data structures associated with utility outage detection logic 110 in a database system (e.g., a computerized utility usage application). The data structures may include, for example, records of estimated or zero-filled (zero-valued) usage data.

In one embodiment, the computer system 100 also includes at least one head-end device 190 operably connected to the computing device 105 and/or a network interface to access the head-end device 190 via a network connection. For example, in one embodiment, the head-end device 190 is operably connected to estimation logic 130 via a validation logic (not shown). In accordance with one embodiment, the validation logic is configured to access (e.g., stream) recently measured meter data from the head-end device 190. The head-end device 190 is configured to collect measured meter data from the utility system (e.g., from an electrical grid). In one embodiment, head-end device 190 is considered to be a part of the utility system and not a part of the system 100.

Referring back to the logics of utility outage detection logic 110 of FIG. 1, in one embodiment, visual user interface logic 120 is configured to generate a graphical user interface (GUI) to facilitate user interaction with utility outage detection logic 110. For example, visual user interface logic 120 includes program code that generates and causes the graphical user interface to be displayed based on an implemented graphical design of the interface. In response to user actions and selections via the GUI, associated aspects of setting thresholds and overriding estimation suppression may be manipulated.

For example, in one embodiment, visual user interface logic 120 is configured to facilitate selecting or entering a threshold value in response to user actions. For example, visual user interface logic 120 may facilitate manual selection of a threshold value from multiple threshold values provided by utility outage detection logic 110. Each threshold value may be pre-stored in a memory of the computing device 105 as data. A selected or entered threshold value may be compared to an aggregate percentage value by comparison logic 140, in accordance with one embodiment, as discussed later herein.

In one embodiment, visual user interface logic 120 is configured to facilitate the manual overriding of suppressing an estimation process in response to user actions. For example, visual user interface logic 120 may facilitate the commanding of suppression logic 160 to override the suppressing of the estimation process of estimation logic 130. A user may select an override command via the graphical user interface which results in an override signal (OVR) being sent to suppression logic 160. Other automatic ways of overriding the suppression process, which do not involve visual user interface logic, are discussed later herein.

Referring again to FIG. 1, in one embodiment, estimation logic 130 is configured to read, parse, and analyze measured meter data (MMD). The measured meter data is data that has been collected from multiple utility meters within a zone (e.g., a postal code zone) of a utility system by a head-end device (e.g., head-end device 190). For this discussion, the system assumes that the measured meter data has been processed through a validation process before being received by the estimation logic 130. The validation process identifies valid usage data and invalid usage data from the measured meter data. Invalid usage data may be a result of bad or corrupted data or gaps (missing data) in the measured meter data, for example. How to identify which data is valid or invalid is beyond the scope of this disclosure and is not discussed in detail. After being identified, the valid usage data and the invalid usage data may be marked with different identifying data bits or flags to distinguish the data from each other. In one embodiment, a bit in a record field may be set to identify a corresponding portion of data as valid or invalid. Depending on the measured meter data being processed, there may be multiple portions of usage data that are identified as invalid.

The estimation logic 130 is configured to parse and identify the invalid usage data within the measured meter data (based on the identifying data bits) so that the invalid usage data is not used in subsequent processes. For example, the invalid data is not used in a billing process for billing customers because using the invalid data would likely result in erroneously billing customers based on incorrect usage data. Instead, the invalid usage data is ultimately replaced with estimated usage data, which is estimated from valid usage data as described below.

Estimation logic 130 is also configured to perform an estimation process on a portion of the measured meter data (e.g., for a meter) to generate corrected meter data. The corrected meter data includes the valid usage data from the portion being processed and estimated usage data. The estimated usage data replaces the invalid usage data that is identified in the portion of measured meter data being processed. The estimated usage data is derived from the valid usage data. For example, an interval of measured meter data under consideration (corresponding to a time interval) having invalid data, may be discarded and replaced with an estimate of usage data based on valid usage data from intervals of data corresponding to time intervals occurring immediately before and after the interval under consideration.

Various estimation techniques may be used to generate estimated usage data, in accordance with various embodiments. Such estimation techniques may include weighted averaging techniques, data interpolation techniques, statistical techniques, probabilistic techniques, and filtering techniques. Other estimation techniques are possible as well, in accordance with other embodiments.

In accordance with one embodiment, estimation logic 130 is configured to send (e.g., transmit) the corrected meter data to other systems that perform other processes on the data. The other systems performing the other processes may be internal to the computing device 105, external to the computing device 105, or both. For example, in one embodiment, the corrected meter data is transmitted to a billing system providing a billing process for billing customers. Furthermore, in one embodiment, estimation logic 130 is configured to send (e.g., transmit) the corrected meter data to aggregation logic 140.

In one embodiment, aggregation logic 140 is configured to read the corrected meter data from estimation logic 130 and aggregate the corrected meter data for the multiple meters within the postal code zone over a time span. In one embodiment, the time span corresponds to a 24-hour day. Aggregating the corrected meter data results in aggregation logic 140 generating an aggregate percentage value a. The aggregate percentage value a defines or specifies a total percentage of meter data received over the time span. A maximum expected amount of corrected meter data may correspond to 100% and is based on statistics of normal usage for the zone (e.g., based on how many meters are normally working properly and sending data). A median usage value over many days may correspond to, for example, 98%.

At the end of a particular day (time span), the aggregate percentage value a is calculated based on the amount of corrected meter data received by aggregation logic 140 for that day and the amount of corrected meter data corresponding to 100%. For example, for a particular day, an amount of corrected meter data may be received for only 5,000 of 10,000 total meters in a zone. Little or no data has been received for the other 5,000, meters. Therefore, the aggregate percentage value a can be calculated to be 50% (i.e., (5,000/10,000)×100), suggesting that half of the zone is experiencing a power outage. In one embodiment, the system “knows” how many meters are in a zone and counts the number of meter identifiers that are associated with the usage data that the system is processing. The ability to choose which head-end/metering technology is examined by zone is provided and is user configurable. For example, one set of meters can be monitored for estimation suppression while meters for a different vendor are not monitored, in accordance with one embodiment.

In one embodiment, comparison logic 150 is configured to, after the time span (e.g., at the end of the day) read the aggregate percentage value a from aggregation logic 140 and compare the aggregate percentage value a to a threshold value T. The threshold value T specifies a percentage level that specifies an acceptable level below an expected percentage level (e.g. a median percentage level) for the zone. In accordance with one embodiment, comparison logic 150 is configured to output a comparison signal Δ when the aggregate percentage value a falls below the threshold value T, indicating a utility outage for the zone.

As an example, the median percentage level for the zone may be 98%. The threshold value T may be a default value (e.g., 40%, 50%) and/or may be set via the graphical user interface provided by the visual user interface logic 120 as displayed on the display screen 170. The threshold value T of 40% is 58% below the median percentage level of 98%. Suppose that in one example the aggregate percentage value a for the zone at the end of the day is determined to be 35%. As a result, comparison logic 150 determines that the aggregate percentage value a (35%) has fallen below the acceptable threshold value T (40%), which triggers a determination that an outage is detected. In response, the comparison logic 150 generates and outputs a comparison signal Δ to indicate an outage for the zone. Otherwise, a signal is generated to indicate that no outage has been detected.

In one embodiment, suppression logic 160 is configured to read the comparison signal Δ output by comparison logic 150. Suppression logic 160 is also configured to generate a control signal ψ, in response to the comparison signal Δ, which when activated commands estimation logic 130 to suppress the estimation process for the multiple meters in the zone. In other words, when a utility outage is detected, the estimation process performed by estimation logic 130 is stopped for the multiple meters of the postal code zone. In this way, the creation of erroneous usage and billing information can be avoided, as further discussed below.

During suppression, while the control signal is active, estimation logic 130 is configured to replace the corrected meter data with zero-valued data, in accordance with one embodiment. That is, instead of generating data structures of corrected meter data having valid usage data and estimated usage data, the data structures are zero-filled (usage data is replaced with zero values that indicate no usage of electricity during a time period). In one embodiment, the zero-filled data structures are stored in the database device 180. Once the estimation process is resumed, the zero-valued data may be replaced with estimated usage data.

Visual user interface logic 120 is configured to provide a graphical user interface that may be displayed on the display screen 170 to facilitate user overriding of the control signal ψ by generating an override signal (OVR), in accordance with one embodiment. For example, when estimation is suppressed, a user may decide to manually override the suppression based on some other knowledge indicating to the user that an outage has not occurred for the zone, or that electrical power has been restored to the zone.

In one embodiment, estimation logic 130 is configured to determine that the estimation process is to resume for a meter of the multiple meters of a suppressed zone based on newly validated usage data received from the validation process. Newly validated usage data for the meter may start being received due to the meter being powered up after a power outage. Estimation logic 130 is also configured to access the zero-valued data corresponding to the meter from the database device 180, upon determining that the estimation process is to be resumed for the meter.

Estimation logic 130 is further configured to resume the estimation process to generate newly estimated usage data, corresponding to the time intervals associated with the zero-valued data for the meter, and replace the zero-valued data with the newly estimated usage data. The newly estimated usage data is estimated (generated) based on the newly validated usage data and/or corrected measurement data generated just before the utility outage. Estimation logic 130 is configured to send (e.g., transmit) the newly estimated usage data, once generated, to a billing process system, for example. Resuming estimation for the other meters in the zone may also occur in a similar manner, for example, as those other meters regain electrical power and send newly validated usage data to estimation logic 130.

In one embodiment, estimation logic 130 is configured to receive a message for a meter of the multiple meters of the zones, sometime after suppression was commanded, indicating that the meter is again powered up (i.e., has regained power). The message may be a part of the measured meter data out of the validation process, in accordance with one embodiment. Estimation logic 130 is also configured to resume the estimation process for the meter in response to receiving the message. Similarly, estimation logic 130 may resume the estimation process for the other meters in the zone upon receiving a similar message for each of the other meters.

In one embodiment, utility outage detection logic 110 is configured to determine that the aggregate percentage value a has returned to a value that is above the threshold value T. For example, utility outage detection logic 110 may determine that the aggregate percentage value a has returned at or near to the expected percentage level for the zone . . . maybe at or near 98%), sometime after suppression was commanded. In response, the estimation process may be resumed. For example, even during suppression, estimation logic 130 may still send at least valid usage data received from the validation process to aggregation logic 140. Aggregation of the valid usage data over a time span (e.g. a day) may be enough to confirm that the power outage is over.

In this manner, utility outage detection logic 110 suppresses the estimation of usage data for the multiple meters within a zone upon detecting an outage. The outage can be detected by aggregating usage data for the multiple meters over a time span (e.g. a day) and determining that the percentage of the aggregated usage data is too low (i.e., below a threshold value). The estimation process can be restored for each meter in several different ways, in accordance with various embodiments.

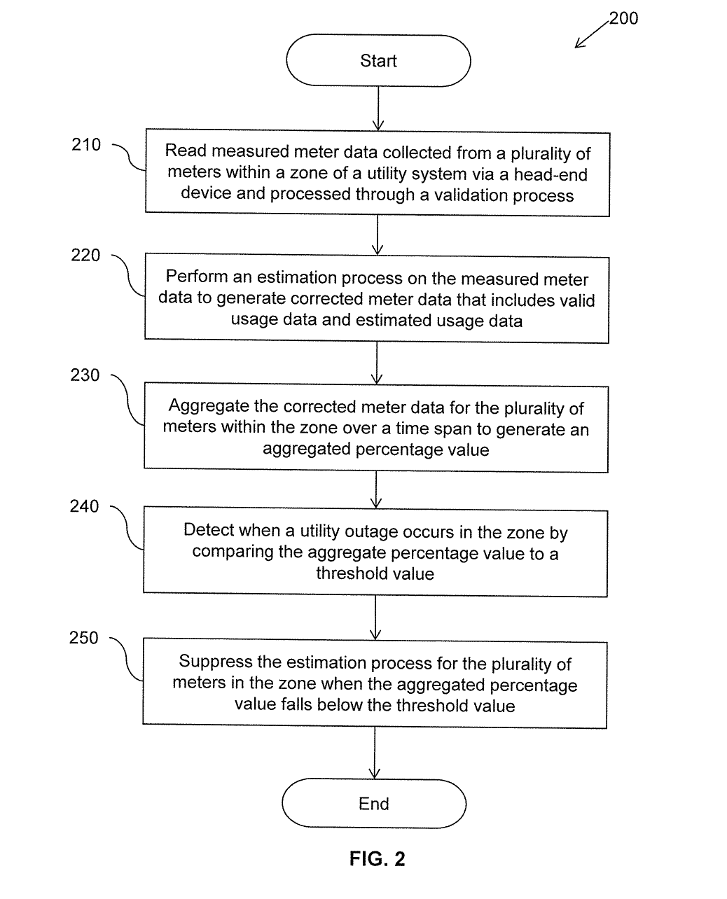

FIG. 2 illustrates one embodiment of a method 200, which can be performed by utility outage detection logic 110 of the computer system 100 of FIG. 1, for suppressing the estimation of usage data during a utility outage (e.g., a power outage). Method 200 describes operations of utility outage detection logic 110 and is implemented to be performed by utility outage detection logic 110 of FIG. 1, or by a computing device configured with an algorithm of the method 200. For example, in one embodiment, method 200 is implemented by a computing device configured to execute a computer application. The computer application is configured to process data in electronic form and includes stored executable instructions that perform the functions of method 200.

Method 200 will be described from the perspective that recently measured meter data from one or more customer utility meters can be accessed via networked computer communications and processed through a validation process. The validation process identifies and tags the various parts of the measured meter data as being valid or invalid (e.g., by performing a statistical comparison to historical meter data). Recently measured meter data may include one or more of interval consumption data or register (scalar) consumption data corresponding to multiple utility meters of consumers in a zone. In one embodiment, the zone is defined by a postal code.

Upon initiating method 200, at block 210, measured meter data is read (e.g., by estimation logic 130 of FIG. 1). The measured meter data corresponds to recent utility (e.g. electrical) usage data that is generated by multiple utility meters. The measured meter data has previously been collected from the multiple utility meters within a zone of a utility system (e.g., an electrical grid) via a head-end device (e.g., head-end device 190 of FIG. 1). The measured meter data has also been processed through a validation process provided by a validation system (not shown) to identify and tag valid usage data and invalid usage data of the measured meter data. Invalid usage data may be a result of bad or corrupted data or gaps (missing data) in the measured meter data, for example, as previously discussed herein.

At block 220, an estimation process is performed (e.g., by estimation logic 130 of FIG. 1) on the measured meter data to generate corrected meter data which includes the valid usage data and estimated usage data. The estimated usage data replaces the invalid usage data of the measured meter data. The estimated usage data is derived at least in part from a portion of the valid usage data, in accordance with one embodiment. For example, an interval of measured meter data under consideration, having invalid data, may be discarded and replaced with an estimate of usage data based on valid register data, or based on some combination of valid register data and valid interval data. In one embodiment, the corrected meter data is transmitted (e.g., by estimation logic 130 of FIG. 1) to a billing process system (not shown).

At block 230, the corrected meter data for the multiple meters of the zone is aggregated (e.g., by aggregation logic 140 of FIG. 1) over a time span (e.g., a day) to generate an aggregate percentage value. The aggregate percentage value specifies a total percentage of data received for the time span, as discussed previously herein. At block 240, after the time span, the aggregate percentage value is compared to a threshold value (e.g., by comparison logic 150 of FIG. 1) in an attempt to detect a utility outage (e.g., an electrical power outage). The threshold value specifies a percentage level below an expected percentage level for the zone, as discussed previously herein. In one embodiment, the threshold value is set by a user (e.g. via a graphical user interface provided by visual user interface logic 120 of FIG. 1 and displayed to the user on display screen 170 of FIG. 1).

At block 250, the estimation process for the multiple meters within the zone is suppressed (e.g. by suppression logic 160 of FIG. 1) when the aggregate percentage value falls below the threshold value (e.g., as determined by comparison logic 150 of FIG. 1), indicating detection of a utility outage within the zone. In one embodiment, while the estimation process is suppressed, the corrected meter data is replaced with zero-valued data which may be stored until the zero-valued data can be replaced with estimated usage data once the estimation process is resumed. This avoids overbilling customers for services (e.g., electrical power, water, gas) that they did not consume during an outage.

The nature of the billing depends on the timing of the billing for each customer. As an example, assume that two customers (customer #1 and customer #2) both live in San Francisco, and a major earthquake occurs on March 29th causing a power outage in their zone. The measured meter data for both customers is filled with zeros on March 30th, but customer #1 is also scheduled to have his bill mailed that same day. The bill for customer #2 isn't scheduled to be mailed until April 7th. The utility will mail the bill for customer #1 with one day filled with the assumed zeros. The earthquake recovery lasts a week and the power to both customers is restored on April 6th. At that point, the usage data for both customers is filled back in with the actual results from the customer meters. Customer #1 will need to be rebilled for the corrected usage for one day (or charged the next month). However, the bill for customer #2 has not been generated and sent yet. Therefore, customer #2 never sees any rebilling because the zeros were corrected before her bill was mailed.

Sometime after suppressing estimation processing for all of the meters in a zone, the estimation process may be resumed in any of several ways. For example, in one embodiment, the estimation process may be resumed for a meter when valid measured meter data starts being received for that meter. In another embodiment, the estimation process may be resumed for a meter when a message is received from that meter indicating that the meter is powered up (i.e., has regained electrical power). In a further embodiment, the estimation process may be resumed when a user overrides the suppression of the estimation process (e.g. via a graphical user interface provided by visual user interface logic 120 of FIG. 1 and displayed to the user on display screen 170 of FIG. 1).

In accordance with one embodiment, the estimation process may be resumed when the aggregate percentage value has returned to a reasonable level (e.g., the expected percentage level) for the zone. As discussed previously herein, even during suppression, at least valid usage data received from the validation process may still be aggregated. Aggregation of the valid usage data over a time span (e.g. a day) may be enough to confirm that the outage is over.

In this manner, the estimation of utility usage data can be suppressed during a utility outage in a zone to avoid overbilling customers. Utility usage data that was not estimated during the outage can be estimated later based on validated measured meter data received just before and/or just after the outage.

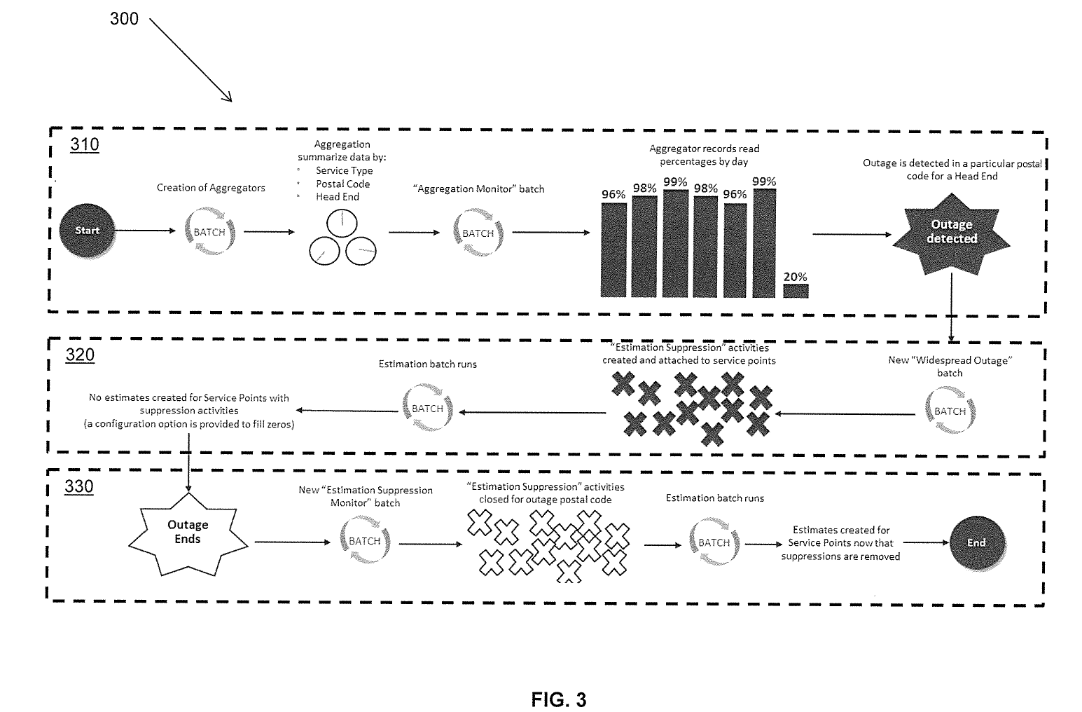

FIG. 3 graphically illustrates an example embodiment of a process 300 of suppressing usage estimation upon detecting a power outage, and resuming usage estimation once the power outage is over. During branch 310 of the process 300, measured meter data is collected and aggregated for each day over multiple days. As shown in branch 310, the aggregate percentage values for the seven (7) past days is 96%, 98%, 99%, 98%, 96%, 99%, and 20%, with 20% corresponding to the most recent day. The aggregate percentage value of 20% for the most recent day falls below a threshold value, indicating that a power outage has occurred in a postal code zone.

During branch 320 of the process 300, usage estimation is suppressed for meters at multiple service points within the postal code zone. Corrected meter data may be replaced with zero-valued data for the meters and stored until estimation can resume. During branch 330 of the process 300, the power outage has ended for the postal code zone and usage estimation is resumed for the meters within the postal code zone. The zero-valued data may be accessed and replaced with newly estimated usage data based on newly validated usage data and/or corrected measurement data generated just before the power outage.

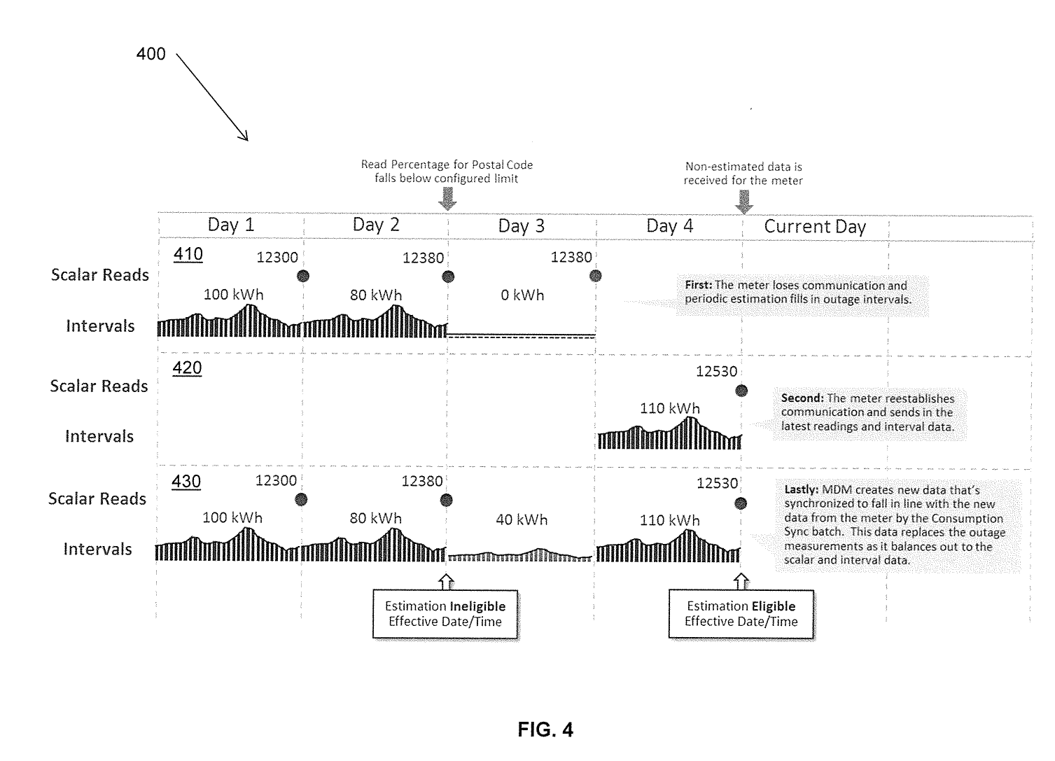

FIG. 4 illustrates an example power outage scenario 400 as handled by the system 100 of FIG. 1 using the method 200 of FIG. 2. Referring to row 410 of FIG. 4, on day 1 and day 2, validated measured meter data (including both register usage data and interval usage data) is received for a meter of a zone from a validation process. At the end of day 2 the aggregate percentage value for the zone has fallen below the threshold value, indicating a power outage for the zone. As a result, usage estimation is suppressed for the zone for day 3 and zero-valued data is generated, for the intervals associated with the meter, instead of corrected meter data. That is, it is assumed that measured meter data is not received for the meter for day 3 because of the power outage.

Referring to row 420 of FIG. 4, during day 4, the meter starts providing measured meter data again out of the validation process. The estimation process for the meter is resumed and the usage for day 3 is then estimated to replace the zero-valued data. The scalar register data at the end of day 4 is 12530 kWh and the scalar register data at the end of day 2 is 12380 kWh. The total power consumed during day 4 is 110 kWh as known from the interval usage data for day 4. Therefore, the system determines that the total amount of power consumed on day 3 by the customer associated with the meter must have been 40 kWh (i.e., 12530−12380−110=40), which is significantly lower than normal usage for that customer (likely due to the power outage).

Referring to row 430 of FIG. 4, the interval usage data for day 3 is filled in to replace the zero-valued data based on everything known at the end of day 4. That is, the 40 kWh of total power used for day 3 is distributed over the intervals of day 3 based on a synchronizing estimation process that takes into account the scalar register data. Depending on the billing day for the customer, the customer may be billed such that the zero-valued data for day 3 is included in the billing (ensuring that the customer is not overbilled), or the customer could be billed such that the estimated usage data for day 3 is included in the billing (reflecting an accurate billing for the month).

In this manner, customers are not overbilled when a power outage occurs. However, customers are eventually billed for the actual power consumed, if any, during a day when a power outage occurs.

Furthermore, other embodiments may be concerned with other types of consumption data and meters other than electrical consumption data and electrical meters. For example, other embodiments may be configured to access and process water consumption data provided by water meters or natural gas consumption data provided by natural gas meters. Such other embodiments may work in a similar manner to the electrical usage examples described herein.

### Computing Device Embodiment

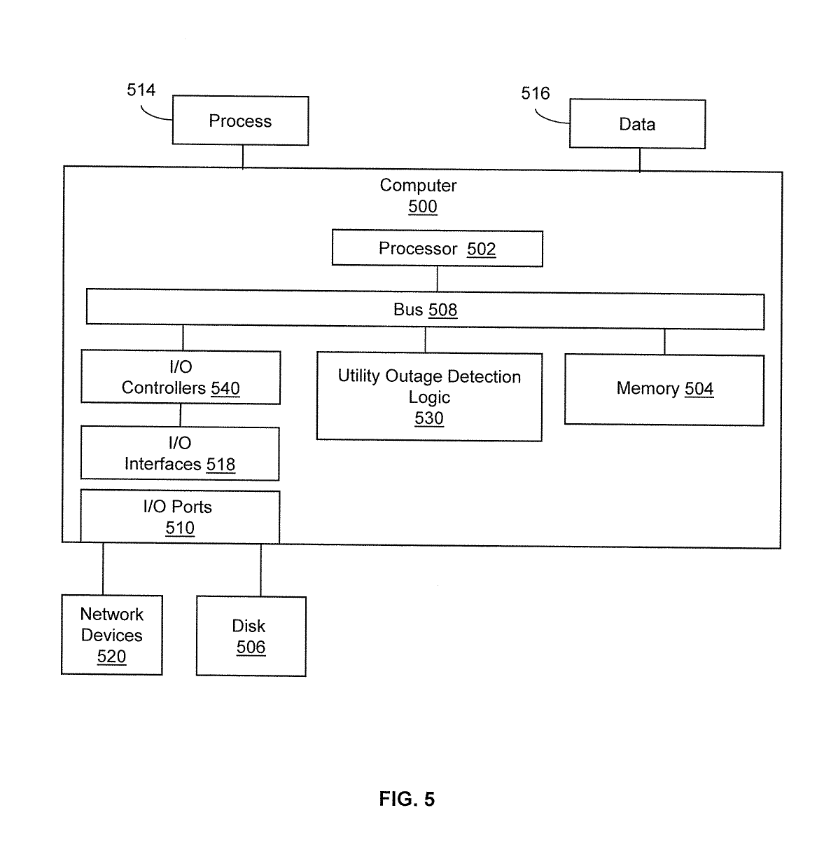

FIG. 5 illustrates an example computing device that is configured and/or programmed with one or more of the example systems and methods described herein, and/or equivalents. FIG. 5 illustrates one example embodiment of a computing device upon which an embodiment of utility outage detection logic may be implemented. The example computing device may be a computer 500 that includes a processor 502, a memory 504, and input/output ports 510 operably connected by a bus 508.

In one example, the computer 500 may include utility outage detection logic 530 (corresponding to utility outage detection logic 110 from FIG. 1) which is configured to suppress an estimation process that corrects invalid meter data for multiple meters within a postal code zone. In different examples, logic 530 may be implemented in hardware, a non-transitory computer-readable medium with stored instructions, firmware, and/or combinations thereof. While the logic 530 is illustrated as a hardware component attached to the bus 508, it is to be appreciated that in other embodiments, logic 530 could be implemented in the processor 502, a module stored in memory 504, or a module stored in disk 506.

In one embodiment, logic 530 or the computer 500 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to facilitate the suppression of an estimation process for estimating utility usage data during a utility outage. The means may also be implemented as stored computer executable instructions that are presented to computer 500 as data 516 that are temporarily stored in memory 504 and then executed by processor 502.

Logic 530 may also provide means (e.g., hardware, non-transitory computer-readable medium that stores executable instructions, firmware) to resume the estimation process in response to determining that the outage has ended.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A storage disk 506 may be operably connected to the computer 500 via, for example, an input/output interface (e.g., card, device) 518 and an input/output port 510. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The computer 500 may interact with input/output devices via the i/o interfaces 518 and the input/output ports 510. Input/output devices may be, for example, a keyboard, a microphone, a pointing and selection device, cameras, video cards, displays, the disk 506, the network devices 520, and so on. The input/output ports 510 may include, for example, serial ports, parallel ports, and USB ports.

The computer 500 can operate in a network environment and thus may be connected to the network devices 520 via the i/o interfaces 518, and/or the i/o ports 510. Through the network devices 520, the computer 500 may interact with a network. Through the network, the computer 500 may be logically connected to remote computers. Networks with which the computer 500 may interact include, but are not limited to, a LAN, a WAN, and other networks.

Systems, methods, and other embodiments have been described that are configured to suppress the estimation of utility usage data, for the purpose of correcting invalid data in measured meter data, for all meters within a postal code zone during a utility outage. In one embodiment, estimation logic reads measured meter data representing utility usage data collected from multiple meters within a zone of a utility system via a head-end device. The measured meter data has been processed through a validation process system that identifies valid usage data and invalid usage data of the measured meter data. Estimation logic performs an estimation process on the measured meter data to generate corrected meter data that includes the valid usage data and estimated usage data that replaces the invalid usage data of the measured meter data. The estimated usage data is derived at least in part from at least a portion of the valid usage data. Aggregation logic reads and aggregates the corrected meter data for the multiple meters within the zone over a time span to generate an aggregate percentage value specifying a total percentage of data received for the time span. Comparison logic detects when a utility outage has occurred by reading and comparing the aggregate percentage value to a threshold value. In response to the aggregate percentage value being below the threshold value, suppression logic generates a control signal to indicate a utility outage is detected within the zone, and suppresses the estimation process on the measured meter data for the multiple meters in the zone via the control signal.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer software embodied in a non-transitory computer-readable medium including an executable algorithm configured to perform the method.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C. §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

ASIC: application specific integrated circuit.

CD: compact disk.

CD-R: CD recordable.

CD-RW: CD rewriteable.

DVD: digital versatile disk and/or digital video disk.

HTTP: hypertext transfer protocol.

LAN: local area network.

RAM: random access memory.

DRAM: dynamic RAM.

SRAM: synchronous RAM.

ROM: read only memory.

PROM: programmable ROM.

EPROM: erasable PROM.

EEPROM: electrically erasable PROM.

USB: universal serial bus.

WAN: wide area network.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). An operable connection may include one entity generating data and storing the data in a memory, and another entity retrieving that data from the memory via, for example, instruction control. Logical and/or physical communication channels can be used to create an operable connection.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C. §101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. §101.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described. Thus, this disclosure is intended to embrace alterations, modifications, and variations that fall within the scope of the appended claims, which satisfy the statutory subject matter requirements of 35 U.S.C. §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

To the extent that the phrase “one or more of, A, B, and C” is used herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be used.

What is claimed is:

1. A computer-implemented method performed by a computing device where the computing device includes at least a processor for executing instructions from a memory, the method comprising:
reading measured meter data, via a processor, wherein the measured meter data represents utility usage data collected from a plurality of meters within a zone of a utility system and processed through a validation process to identify valid usage data and invalid usage data of the measured meter data;
performing an estimation process, via the processor, on the measured meter data to generate corrected meter data that includes the valid usage data and estimated usage data that replaces the invalid usage data within the measured meter data, wherein the estimated usage data is derived at least in part from at least a portion of the valid usage data;
aggregating the corrected meter data, via the processor, for the plurality of meters within the zone over a time span to generate an aggregate percentage value specifying a total percentage of data received for the time span;
detecting when a utility outage has occurred in the zone by comparing, by the processor, the aggregate percentage value to a threshold value; and
in response to the aggregate percentage value being below the threshold value, generating a control signal to indicate a utility outage is detected within the zone and suppressing, by the processor, the estimation process on the measured meter data for the plurality of meters in the zone in response to the control signal.

2. The method of claim 1, further comprising, while the estimation process is suppressed, replacing the corrected meter data with zero-valued data via the processor.

3. The method of claim 1, further comprising, while the estimation process is not suppressed, transmitting the corrected meter data, via the processor, to a billing process system.

4. The method of claim 1, further comprising:
after the suppressing, receiving valid measured meter data, via the processor, for at least one meter of the plurality of meters; and
resuming the estimation process, via the processor, for the at least one meter in response to receiving the valid measured meter data for the at least one meter.

5. The method of claim 1, further comprising:
after the suppressing, receiving a message for at least one meter of the plurality of meters, via the processor, indicating that the at least one meter is powered up; and
resuming the estimation process, via the processor, for the at least one meter in response to receiving the message.

6. The method of claim 1, further comprising:
after the suppressing, determining, via the processor, that the aggregate percentage value has returned above the threshold value; and
resuming the estimation process, via the processor, for the plurality of meters in response to the determining.

7. The method of claim 1, wherein the measured meter data includes at least one of interval consumption data or register (scalar) consumption data corresponding to the plurality of meters.

8. The method of claim 1, further comprising providing a graphical user interface, via the processor, that facilitates user setting of the threshold value.

9. The method of claim 1, further comprising providing a graphical user interface, via the processor, that facilitates user overriding of the suppressing of the estimation process.

10. The method of claim 1, wherein the zone corresponds to a postal code.

11. A computing system, comprising:
a processor;
an estimation module stored in a non-transitory computer-readable medium including instructions that when executed cause the processor to:
read measured meter data representing utility usage data collected from a plurality of meters within a zone of a utility system and processed through a validation process system to identify valid usage data and invalid usage data of the measured meter data, and
perform an estimation process on the measured meter data to generate corrected meter data that includes the valid usage data and estimated usage data that replaces the invalid usage data within the measured meter data, wherein the estimated usage data is derived at least in part from at least a portion of the valid usage data;
an aggregation module stored in the non-transitory computer-readable medium including instructions that when executed cause the processor to read and aggregate the corrected meter data for the plurality of meters within the zone over a time span to generate an aggregate percentage value specifying a total percentage of data received for the time span;
a comparison module stored in the non-transitory computer-readable medium including instructions that when executed cause the processor to detect when a utility outage has occurred by reading and comparing the aggregate percentage value to a threshold value; and
a suppression module stored in the non-transitory computer-readable medium including instructions that when executed cause the processor to, in response to the aggregate percentage value being below the threshold value, generate a control signal to indicate a utility outage is detected within the zone and suppress the estimation process on the measured meter data for the plurality of meters in the zone via the control signal.

12. The computing system of claim 11, wherein the estimation module stored in the non-transitory computer-readable medium includes instructions that when executed cause the processor to, while the estimation process is not suppressed, transmit the corrected meter data to a billing process system.

13. The computing system of claim 11, further comprising a visual user interface module stored in the non-transitory computer-readable medium including instructions that when executed cause the processor to provide a graphical user interface that facilitates user setting of the threshold value and user overriding of the control signal to cause the estimation module to resume the estimation process.

14. The computing system of claim 13, further comprising a display screen configured to display and facilitate user interaction with at least the graphical user interface provided by the visual user interface module.

15. The computing system of claim 11, wherein the estimation module stored in the non-transitory computer-readable medium includes instructions that when executed cause the processor to, while the estimation process is suppressed, replace the corrected meter data with zero-valued data.

16. The computing system of claim 15, further comprising a database device configured to store the zero-valued data.

17. The computing system of claim 16, wherein the estimation module stored in the non-transitory computer-readable medium includes instructions that when executed cause the processor to:
determine that the estimation process is to resume for a meter of the plurality of meters based on newly validated usage data received from the validation process system;
access the zero-valued data for the meter from the database device;
resume the estimation process to generate newly estimated usage data, corresponding to time intervals of the zero-valued data for the meter, based at least on the newly validated usage data;
replace the zero-valued data for the meter with the newly estimated usage data corresponding to the time intervals of the zero-valued data for the meter; and
transmit the newly estimated usage data to a billing process system.

18. A non-transitory computer-readable medium storing instructions that, when executed by one or more processors of a computing device, cause the computing device to at least:
read measured meter data, via the one or more processors, wherein the measured meter data represents utility usage data collected from a plurality of meters within a zone of a utility system and processed through a validation process to identify valid usage data and invalid usage data of the measured meter data;
perform an estimation process, via the one or more processors, on the measured meter data to generate corrected meter data that includes the valid usage data and estimated usage data that replaces the invalid usage data of the measured meter data, wherein the estimated usage data is derived at least in part from at least a portion of the valid usage data;
aggregate the corrected meter data, via the one or more processors, for the plurality of meters within the zone over a time span to generate an aggregate percentage value specifying a total percentage of data received for the time span;
detecting when a utility outage has occurred in the zone by comparing the aggregate percentage value to a threshold value, via the one or more processors; and
in response to the aggregate percentage value being below the threshold value, generate a control signal, via the one or more processors, to indicate a utility outage is detected within the zone, and suppress the estimation process on the measured meter data for the plurality of meters in the zone, via the one or more processors, in response to the control signal.

19. The non-transitory computer-readable medium of claim 18, wherein the instructions further comprise instructions that, when executed by the one or more processors, cause the computing device to at least, while the estimation process is suppressed, replace the corrected meter data with zero-valued data.

20. The non-transitory computer-readable medium of claim 18, wherein the instructions further comprise instructions that, when executed by the one or more processors, cause the computing device to at least, while the estimation process is not suppressed, transmit the corrected meter data to a billing process system.
